(19) United States
(12) Patent Application Publication
(10) Pub. No.: US 2011/0071895 A1
(43) Pub. Date: Mar. 24, 2011

(54) SYSTEMS AND METHODS FOR DIGITIZED LOYALTY PROGRAMS AND TARGETED MOBILE ADVERTISEMENTS

(76) Inventor: Rabih C. Masri, Charlottesville, VA (US)

(21) Appl. No.: 12/886,790

(22) Filed: Sep. 21, 2010

Related U.S. Application Data
(60) Provisional application No. 61/244,375, filed on Sep. 21, 2009.

(51) Int. Cl. G06Q 30/00; G06K 19/06

(52) U.S. Cl. 705/14.27; 235/375

(57) ABSTRACT

In some embodiments, a non-transitory processor-readable medium stores code representing instructions to cause a processor to retrieve, from a vendor database, an indicator of each vendor from a set of vendors within a geographic area having registered loyalty programs. The instructions cause the processor to send the indicator of each vendor from the set of vendors to a communication device such that the communication device can display a representation of a geographic location of each vendor from the set of vendors on a map of the geographic area. The instructions further cause the processor to receive a signal from the communication device indicating that a user has selected to subscribe to a loyalty program of a vendor from the set of vendors and to provide, in response to the signal, feedback to the vendor that the user has subscribed to the loyalty program of the vendor.

### CROSS-REFERENCE TO RELATED APPLICATION

This application claims priority to and the benefit of U.S. Provisional Patent Application Ser. No. 61/244,375, filed Sep. 21, 2009, and entitled “Systems and Methods for Digitized Loyalty Programs and Targeted Mobile Advertisements,” which is incorporated herein by reference it its entirety.

### BACKGROUND

Embodiments described herein relate generally to business loyalty and promotion applications and more particularly, to systems and methods for tracking the use of reward and/or loyalty programs and promotions.

Loyalty cards are currently used by many businesses to entice users to continually visit their business. Such loyalty cards are used to provide members of a rewards program with various coupons and/or advertisements. For example, many grocery stores offer discounts for users that use a loyalty card. For another example, businesses often use loyalty cards that are punched and/or marked when a user makes a purchase. When the user reaches a predetermined number of purchases (e.g., punches or marks on their card) they receive something for a reduced price or something for free.

Such known loyalty cards can be easily lost and/or are difficult to keep track of. Additionally, when an individual has multiple loyalty cards, it can be difficult and/or cumbersome to carry all of the cards. Further, the businesses that use such known loyalty cards often do not track the purchases made by their customers and/or the promotions or coupons redeemed by their customers. Accordingly, the businesses are unable to determine which promotions are most effective and attract the greatest number of customers.

Thus, a need exists for a rewards system that allows customers to easily maintain, keep track of and carry all of their rewards cards. Further a need exists for a rewards system that allows businesses to easily keep track of and monitor purchases made and/or promotions or coupons redeemed by their customers.

### SUMMARY

In some embodiments, a non-transitory processor-readable medium stores code representing instructions to cause a processor to retrieve, from a vendor database, an indicator of each vendor from a set of vendors within a geographic area having registered loyalty programs. The instructions cause the processor to send the indicator of each vendor from the set of vendors to a communication device such that the communication device can display a representation of a geographic location of each vendor from the set of vendors on a map of the geographic area. The instructions further cause the processor to receive a signal from the communication device indicating that a user has selected to subscribe to a loyalty program of a vendor from the set of vendors and to provide, in response to the signal, feedback to the vendor that the user has subscribed to the loyalty program of the vendor.

### BRIEF DESCRIPTION OF THE DRAWINGS

FIG. 1A is a schematic diagram that illustrates communication devices in communication with a host device via a network, according to an embodiment.

FIG. 1B is a schematic diagram of a processor of the host device of FIG. 1A.

FIG. 2 is a screen flow diagram illustrating the screens viewable by a user of a rewards program management application, according to another embodiment.

FIGS. 3-14 are screen shots of the rewards program management application of FIG. 2.

FIG. 15 is a screen flow diagram illustrating the screens viewable by a user of a rewards program application, according to another embodiment.

FIGS. 16-22 are screen shots of the rewards program application of FIG. 15.

FIG. 23 is a screen flow diagram illustrating the screens viewable by a user of a rewards program application, according to another embodiment.

FIGS. 24-26 are screen shots of the rewards program application of FIG. 23.

FIG. 27 is a flow chart illustrating a method of searching for and enrolling in a vendor's loyalty program, according to another embodiment.

FIG. 28 is a flow chart illustrating a method of initiating a loyalty program and a promotion, according to another embodiment.

### DETAILED DESCRIPTION

In some embodiments, a non-transitory processor-readable medium stores code representing instructions to cause a processor to retrieve, from a vendor database, an indicator of each vendor from a set of vendors within a geographic area having registered loyalty programs. The instructions cause the processor to send the indicator of each vendor from the set of vendors to a communication device such that the communication device can display a representation of a geographic location of each vendor from the set of vendors on a map of the geographic area. The instructions further cause the processor to receive a signal from the communication device indicating that a user has selected to subscribe to a loyalty program of a vendor from the set of vendors and to provide, in response to the signal, feedback to the vendor that the user has subscribed to the loyalty program of the vendor.

In some embodiments, a non-transitory processor-readable medium stores code representing instructions to cause a processor to receive, at a host device, a first signal from a first communication device indicating that a vendor has selected to initiate a loyalty program and receive, at the host device, a second signal from the first communication device indicating that the vendor has selected to initiate a promotion. The instructions cause the processor to send, in response to the first signal, a first indicator associated with the loyalty program to a second communication device. The first indicator identifies a user of the second communication device and the loyalty program of the vendor such that the vendor can track participation of the user in the loyalty program by providing the first indicator to the host device. The instructions cause the processor to send, in response to the second signal, a second indicator associated with the promotion to the second communication device. The second indicator identifies the user, an expiration date of the promotion, a location at which the promotion is valid, and a parameter of the promotion such that the vendor can track use of the promotion by the user by providing the second indicator to the host device.

In some embodiments, a system includes a search module, an initiation module and a redemption module. The search module can retrieve, from a vendor database, an indicator of each vendor from a set of vendors within a geographic area having registered loyalty programs such that a communication device can display a representation of a geographic location of each vendor from the set of vendors on a map of the geographic area based on the indicator of each vendor from the set of vendors. The initiation module can receive an indication from the communication device that a user has selected to subscribe to a loyalty program of a vendor from the set of vendors. The initiation module can send an indicator associated with the loyalty program to the communication device. The redemption module can increment a use counter associated with the user and the loyalty program in response to receiving an indication from the vendor that the user has presented the indicator to the vendor in association with the loyalty program. The redemption module to provide feedback, including demographic information of the user, to the vendor in response to the user presenting the indicator to the vendor.

As used herein, a rewards program and/or a loyalty program can be, for example, any program used by a vendor to entice customers to continue to purchase goods and/or services from the vendor. For example, a rewards program can be associated with restaurants, grocery stores, department stores, a group of stores (e.g., a mall), online stores and/or any other vendor or group of vendors. Once a user signs up for and/or subscribes to the rewards program, the vendor can provide promotions (e.g., coupons, sale advertisements, etc.) to the user. In some embodiments, the vendor can provide incentives to users to purchase goods and/or services from the vendor by providing free and/or reduced priced goods and/or services to a member of their rewards program based on the amount of goods or services already purchased by the member of the rewards program. For example, if a member of a rewards program for a sandwich shop purchases ten sandwiches, they might get the eleventh sandwich free. For another example, if a member of a rewards program for a gas station purchases $100 worth of gasoline, they might get $5.00 of free gasoline.

As used herein, a promotion can be, for example, any one-time coupon and/or advertisement provided to a user of a rewards program application. Such a coupon and/or advertisement can be as a result of the user searching for the coupon and/or advertisement (e.g., pulling the advertisement) or as a result of the vendor initiating and sending a targeted advertisement to various users of a rewards program application (e.g., pushing the advertisement). In some embodiments, a promotion can be sent to a member of a vendor's loyalty program once the member fulfills a condition of the loyalty program. For example, if the user is a member of a rewards program offering a free sandwich for every ten sandwiches purchased, after the user purchases ten sandwiches, they can be provided a promotion for a free sandwich.

As used in this specification, the singular forms “a,” “an” and “the” include plural referents unless the context clearly dictates otherwise. Thus, for example, the term “a communication device” is intended to mean a single communication device or multiple communication devices; and “network” is intended to mean one or more networks, or a combination thereof.

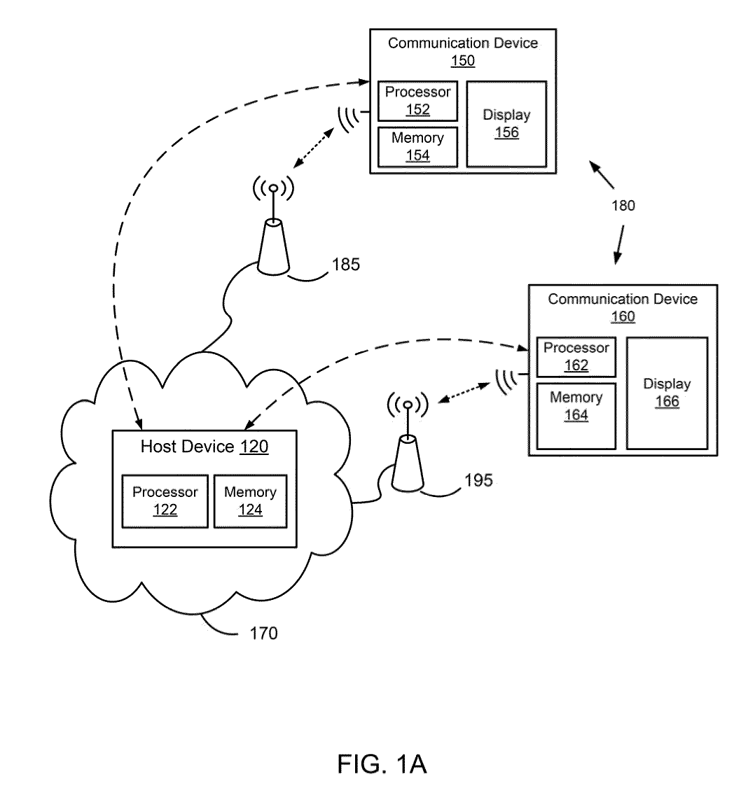

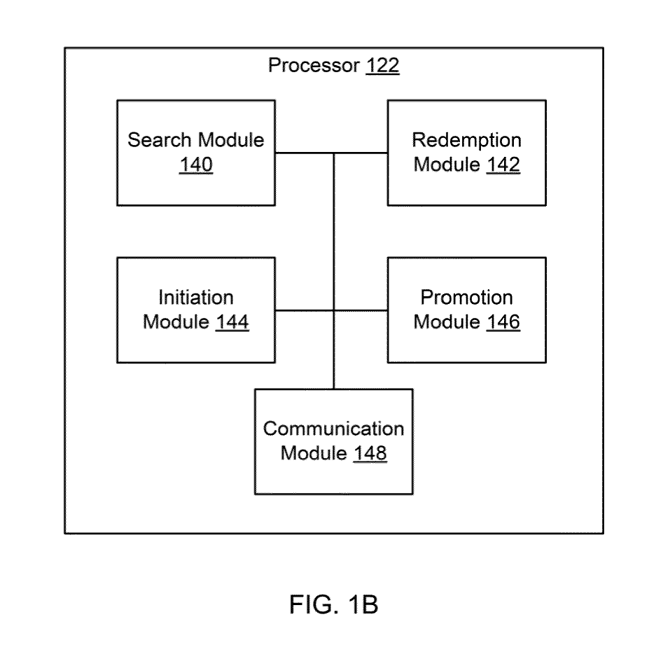

FIG. 1A is a schematic diagram that illustrates communication devices 180 in communication with a host device 120 via a network 170, according to an embodiment. Specifically, communication device 150 is configured to communicate wirelessly with the host device 120 via a gateway device 185. Similarly, communication device 160 is configured to communicate wirelessly with the host device 120 via a gateway device 195. The network 170 can be any type of network (e.g., a local area network (LAN), a wide area network (WAN), a virtual network, a telecommunications network) implemented as a wired network and/or wireless network. In some embodiments, for example, the communication devices 180 are mobile telephones connected to the host device 120 via cellular telephone towers (e.g., gateway devices 185, 195) and a telecommunications network (e.g., network 170).

Each of the communication devices 180 can be, for example, a computing entity (e.g., a personal computing device such as a desktop computer, a laptop computer, etc.), a mobile phone, a monitoring device, a personal digital assistant (PDA), a data capture device (DCD) and/or so forth. Although not shown, in some embodiments, each of the communication devices 180 can include one or more network interface devices (e.g., a network interface card) configured to connect the communication devices 180 to the gateway devices 185, 195. In some embodiments, the communication devices 180 can be referred to as client devices.

As shown in FIG. 1A, the communication device 160 has a processor 162, a memory 164, and a display 166. The memory 164 can be, for example, a random access memory (RAM), a memory buffer, a hard drive, and/or so forth. The display 166 can be any suitable display, such as, for example, a liquid crystal display (LCD) or the like. In some embodiments, the communication device 160 is a mobile communication device running a mobile platform, such as those developed by, for example, Microsoft (e.g., Microsoft Windows Mobile), Research in Motion (e.g., RIM Blackberry), Google (e.g., Android), Symbian, Palm, Apple, and/or the like. Similar to communication device 160, the communication device 150 has a processor 152, a memory 154, and a display 156. In other embodiments, one or more of the communication devices 180 does not include a display. In such embodiments, one of the communication devices 180 can be, for example, a DCD having a scanner (e.g., a barcode scanner) but not a display. As described in further detail herein, such a DCD can be used to enter information (e.g., scan a barcode) associated with the loyalty programs. In other embodiments, such a DCD also includes a display.

In some embodiments, a rewards program application and/or a rewards program management application can be stored in the memories 154, 164 of the communication devices 180. As such, the processors 152, 162 can be configured to process and cause the displays 156, 166 to display information associated with the rewards program application and/or the rewards program management application. In some embodiments, for example, a rewards program application is running on communication device 160 and a rewards program management application is running on communication device 150.

In some embodiments, a rewards program application can be an application that provides a user with a repository for various rewards program accounts and/or provides a user with access to promotions, coupons and/or other benefits, as described in further detail herein. In some embodiments, the rewards program application allows a user to sign up for and/or subscribe to various rewards programs in which they are interested and/or search for promotions from vendors. As described above, a rewards program can be associated with a vendor. For example, the rewards programs can be associated with restaurants, grocery stores, department stores, a group of stores (e.g., a mall), online stores and/or any other vendor or group of vendors. Once a user signs up for the rewards program, the vendor can provide promotions (e.g., coupons, sale advertisements, etc.) to the user via the rewards program application on the user's communication device, as described in further detail herein. Additionally, in some embodiments, the user can search for and find vendors, vendors with rewards programs and/or coupons associated with such vendors based on location (e.g., within 10 miles), type of vendor (e.g., Thai restaurants, department stores) and/or any other suitable criteria using the rewards program application on the user's communication device, as described in further details herein. Such a rewards program application can also store and/or replace the loyalty cards previously used by the users of the rewards programs.

In some embodiments, a rewards program management application is an application that allows a vendor to view data associated with their rewards program. As described in further detail herein, for example, the rewards program management application allows a vendor to view who is using the rewards program, what users of the rewards program are purchasing, the amount of business generated by the rewards program, the amount of business generated by each aspect of the rewards program (e.g., which coupons are used), the percentage of total sales that can be attributed to the rewards program and/or the like. The rewards program management application also allows a vendor to send coupons and/or advertisements to the members of their rewards program and/or potential members of their rewards program, as described in further detail herein.

The host device 120 can be any type of device configured to send data over the network 170 to and/or receive data from one or more of the communication devices 180. In some embodiments, the host device 120 can be configured to function as, for example, a server device (e.g., a web server device), a network management device, and/or so forth.

The host device 120 includes a memory 124 and a processor 122. The memory 124 can be, for example, a random access memory (RAM), a memory buffer, a hard drive, and/or so forth. In some embodiments, the host device 120 receives data associated with rewards programs and stores the data. Such data can include, customer data, account information, trends associated with various rewards programs, and/or the like. Additionally, in some embodiments, the host device 120 can send data to the communication devices 180. For example, if the data received pertains to a rewards program, the host device 120 can send the data to the communication device 160 running the rewards program management application associated with the rewards program. Similarly, if the data received pertains to a new promotion associated with a specific rewards program, the host device 120 can send the data to the members of the rewards program.

In some embodiments, the memory 124 of the host device 120, and/or a separate memory and/or database operatively coupled to the host device 120, acts as a data repository. In such embodiments, the data associated with the rewards program (coupons, data pertaining to an individual user, statistical data, and/or the like) is stored in the memory 124 of the host device 120. When a user wishes to view data associated with their specific user type and/or credentials (e.g., whether the user is a vendor or a consumer), the host device 120 can send such data to the user when a signal requesting the data is received from a communication device 180.

Further, in some embodiments, the memory 124 of the host device 120, and/or a separate memory and/or database operatively coupled to the host device 120, stores account information associated with the users. In such embodiments, the rewards program application and the rewards program management application running on the communication devices 180 act as thin clients. As such, in some embodiments, the rewards program application and the rewards program management application can be viewed by a user using, for example, a web browser and/or a specific thin client running on the communication device 150 or the communication device 160. This allows minimal data to be stored on the communication devices 180.

Additionally, in some embodiments, the memory 124 of the host device 120, and/or a separate memory and/or database operatively coupled to the host device 120, can act as a vendor database. Such a vendor database can store information associated with vendors. Such information can include, for example, information associated with vendor reward and/or loyalty programs; vendor coupons and/or promotions; a geographic location of a vendor; a menu, product offering and/or list of services associated with the vendor; and/or the like.

FIG. 1B is a schematic diagram of the processor 122 of the host device 120. The processor 122 includes and/or executes a search module 140, a redemption module 142, an initiation module 144, a promotion module 146, and a communication module 148. While each module is shown in FIG. 1B as being in direct communication with every other module, in other embodiments, each module need not be in direct communication with every other module.

The communication module 148 is configured to facilitate communication between the host device 122 and the network 170. This allows the host device 122 to send data to and/or receive data from the communication devices 180. For example, the communication module 148 can receive a request to join a loyalty program from a communication device 170 and send the request to the initiation module 144, as described in further detail herein.

The search module 140 is configured to receive a signal from a communication device 150 (via the communication module 148) with one or more search parameters. The search module 140 can then query a vendor database to retrieve information matching the search parameters. The search module 140 can then send the information to the communication device 150 (via the communication module 148). For example, as described in further detail herein, a communication device 150 can send a signal having a location as a parameter to the search module 140. The search module 140 can query the vendor database to retrieve the vendors with loyalty programs within a proximity to that location. Identifiers of the vendors can be sent to the communication device 150 and presented to a user of the communication device 150.

The initiation module 144 is configured to receive a signal from a communication device 150 (via the communication module 148) with a request from a user of a rewards program application to enroll, subscribe to, and/or join a vendor's rewards and/or loyalty program. Based on this request, the initiation module 144 can enroll the user to the rewards and/or loyalty program. As described in further detail herein, an identifier (e.g., barcode, number, etc.) can be sent to the communication device 150 in response to the initiation module 144 enrolling the user in the rewards and/or loyalty program. The user can present the identifier to the vendor when purchasing goods and/or services from the vendor.

In some embodiments, in response to the initiation module 144 enrolling a user in a vendor's loyalty and/or rewards program, the initiation module 144 can send feedback to the vendor. For example, the user can receive the feedback via the vendor's rewards program management application. In some embodiments, the feedback can be sent instantaneously (i.e., within a small time period after the initiation module 144 has enrolled the user in the vendor's loyalty program). In some embodiments, the feedback can include a profile of the user that subscribed to the vendor's loyalty and/or rewards program. Such a profile can include demographic information (e.g., sex, age, geographic location, economic information, etc.), preferences, and/or the like. In some embodiments, the profile includes personally identifiable information (e.g., name, address, telephone number, etc.). In other embodiments, the profile does not include personally identifiable information.

The redemption module 142 is configured to receive a signal from a communication device 160 (via the communication module 148) indicating that the user has presented the identifier to a vendor. For example, the signal can be sent from a communication device of the vendor (e.g., a DCD) in response to the vendor scanning a barcode encoding the identifier. In response to receiving the signal the redemption module 142 can increment a use counter associated with the user and the loyalty program. Additionally, the redemption module 142 can compare the use counter with a predetermined threshold. If the use counter is greater than the predetermined threshold, the redemption module 142 can send (via the communication module 148) an indication of a reward (e.g., a coupon) to the communication device 150. The user of the communication device 150 can then redeem the coupon by presenting the coupon (e.g., a barcode and/or identifier associated with the coupon) to the vendor. The redemption module 142 can then reset the use counter associated with the user and the loyalty program.

The promotion module 146 can send a promotion, targeted advertisement and/or coupon to a communication device in response to a vendor initiating the promotion, targeted advertisement and/or coupon. Additionally, in some embodiments, the promotion module 146 can query a promotion database based on one or more search parameters provided to the promotion module 146 by the communication device 150. The promotion module 146 can send the results of the query (e.g., the coupons and/or promotions that match the search parameters) to the communication device 150. A user of the communication device 150 can then redeem the promotions and/or coupons by presenting them to a vendor (e.g., allowing a vendor to scan a barcode of a promotion and/or coupon).

The promotion module 146 can also receive an indication from a vendor that a user has redeemed a promotion and/or coupon (e.g., when the vendor scans a barcode of the promotion and/or coupon). In response to this indication, the promotion module 146 can store information associated with the user's redemption of the coupon in a user database. For example, the promotion module 146 can store an identifier associated with the user, an identifier associated with the coupon and/or promotion, a time the coupon and/or promotion was redeemed, a location at which the coupon and/or promotion was redeemed and/or the like.

In some embodiments, the data sent between the communication devices 180 and the host device 120 can be formatted using any suitable format. In some embodiments, for example, the data can be formatted using extensible markup language (XML) and/or the like.

In some embodiments, one or more portions of the host device 120 and/or one or more portions of the communication devices 180 can include a hardware-based module (e.g., a digital signal processor (DSP), a field programmable gate array (FPGA)) and/or a software-based module (e.g., a module of computer code, a set of processor-readable instructions that can be executed at a processor). In some embodiments, one or more of the functions associated with the host device 120 (e.g., the functions associated with the processor 122) can be included in one or more modules. In some embodiments, one or more of the functions associated with the communication devices 180 (e.g., functions associated with processor 152 or processor 162) can be included in one or more modules. In some embodiments, one or more of the communication devices 180 can be configured to perform one or more functions associated with the host device 120, and vice versa.

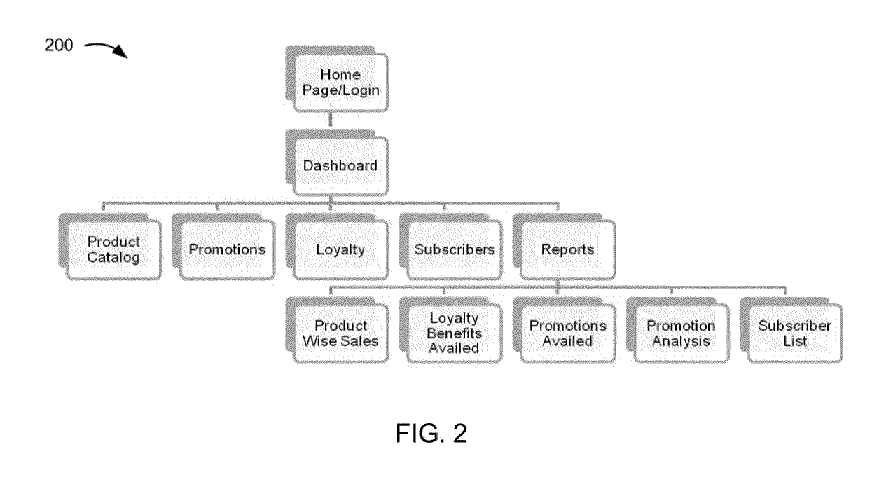

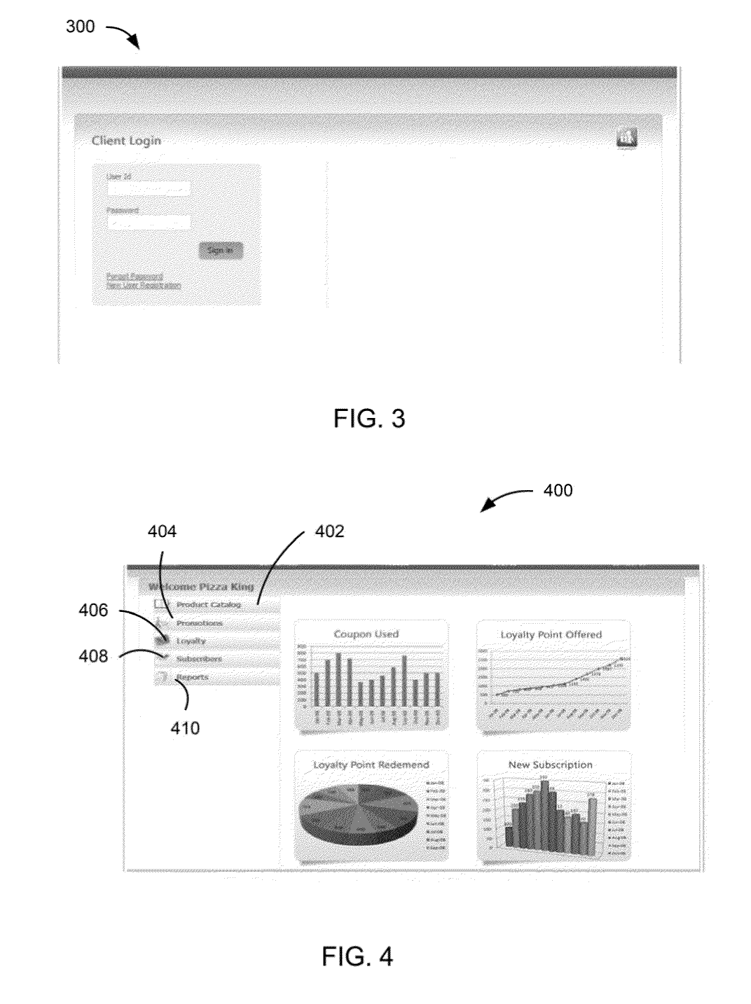

FIG. 2 is a screen flow diagram 200 illustrating the screens viewable by a user of a rewards program management application, according to another embodiment. Such screens are shown and described in further detail with respect to FIGS. 3-14. In some embodiments, the rewards program management application is running on a communication device (e.g., communication device 150 or communication device 160, shown and described in FIG. 1A). As such, the rewards program management application can access data stored in the memory of a host device. Additionally, the rewards program management application can send data to and receive data from the host device.

FIG. 3 shows a login screen 300 of a rewards program management application running on a communication device. A vendor can enter a user name and password in the provided textboxes 310, 320, respectively, to access data associated with the vendor's rewards program. In other embodiments, any other suitable type of login can be used, such as, for example, a biometric login, a proximity card login, a Radio Frequency (RF) identification login, and/or the like. The user name and password can be authenticated with a host device (e.g., host device 120) to allow a vendor access to the data. As discussed above, the data associated with the rewards program can be stored in a memory of the host device. In other embodiments, the memory associated with the rewards program can be stored locally on the communication device.

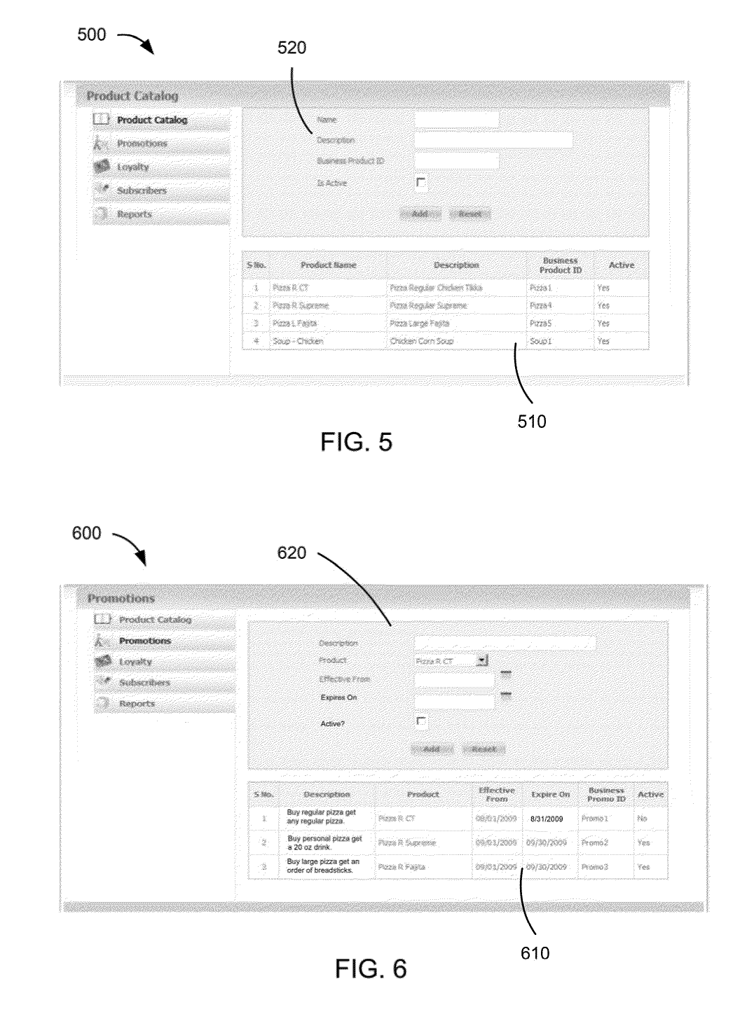

FIG. 4 shows a dashboard screen 400 of a rewards program management application. After a vendor logs into the rewards program management application, the dashboard screen 400 can be displayed. From the dashboard screen 400, the vendor can access data associated with their product catalog (by selecting button 402), data associated with promotions offered by the vendor (by selecting button 404), data associated with their loyalty programs (by selecting button 406), data associated with the subscribers to their loyalty program (by selecting button 408), and/or reports associated with their loyalty programs and/or promotions (by selecting button 410). The buttons 402, 404, 406, 408 and 410 can be displayed on the other screens (e.g., shown in FIGS. 5-14) of the rewards program management application such that a vendor can navigate to other screens and/or access additional functionality associated with the rewards program management application.

FIG. 5 shows a product catalog screen 500 of a rewards program management application. The product catalog screen includes a listing 510 of the products and/or services offered by the vendor. For example, FIG. 5 shows a product catalog for a restaurant. As shown in FIG. 5, the restaurant offers three types of pizza (R CT, R Supreme, L Fajita) and one soup (Chicken). In some embodiments, a vendor can import their entire menu into the rewards program management application. In some embodiments, for example, a user can search for a vendor's menu items, services and/or products using a rewards program application, as described in further detail herein. In other embodiments, the vendor enters menu items, services and/or products as promotions are available for those menu items, services and/or products. Similarly stated, in such embodiments, a vendor can input a menu item, service and/or product into the rewards program management application when defining and/or initiating a promotion associated with that menu item, service and/or product. Using the form 520 displayed on the product catalog screen 500, the vendor can update their product catalog. In other embodiments, the rewards program management application can be linked to a database controlled by the vendor and used by the vendor to maintain menu items, services and/or products. In such embodiments, the rewards program management application database can be automatically updated when the vendor's database is updated.

FIG. 6 shows a promotions screen 600 of a rewards program management application. The promotions screen 600 displays a list 610 of pulled-promotions (including coupons) offered by the vendor. As used herein, pulled-promotions can include any coupons, advertisements, promotions and/or deals that can be accessed (e.g., pulled) by users of a rewards program application. Similarly stated, a user can search for and find a pulled-promotion using a rewards program application using, for example, key words, geographic location, recommendations, vendor name, and/or the like. In some embodiments and as described in further detail herein, a user need not be a member of a vendor's rewards program to access and/or search for a pulled-promotion. In some embodiments, a vendor can pay for a pulled-promotion based on a length of time the pulled-promotion is available (e.g., based on an initiation date and an expiration date), a number of keywords a user can use to search for the pulled-promotion, a priority level of the pulled-promotion (e.g., where displayed in a search results list), and/or the like. The list 610 of pulled-promotions illustrates examples of pulled-promotions for a pizzeria. For example, an example pulled-promotion can include “Buy personal pizza get a 20 oz drink” that is effective during the month of September.

The promotions screen also allows a vendor to define and/or initiate new pulled-promotions using form 620. For example, a vendor can provide a description for the pulled-promotion, can specify a product associated with the pulled-promotion, can specify an effective date (i.e., a start date) for the pulled-promotion, can specify an expiration date (i.e., an end date) for the pulled-promotion and/or the like. In some embodiments, the user can also specify the locations at which the pulled-promotion is valid, a redemption limit for the pulled-promotion (e.g., the pulled-promotion expires after a predetermined number of users have redeemed the pulled-promotion), a redemption limit for each user (e.g., a user can redeem the pulled-promotion only a predetermined number of times), and/or the like.

In some embodiments, the form 620 on the promotions screen 600 provides various user interface controls (e.g., drop-down lists, text boxes, radio buttons, check boxes, lists, etc.) that allow the vendor to define and/or initiate new pulled-promotions. In such embodiments, for example, the vendor can make predetermined selections (e.g., products, dates, redemption limits) for the pulled-promotion using such user interface controls. Using user interface controls having predefined and/or pre-populated values (e.g., a drop down list allowing a vendor to select a product for use in the pulled-promotion, a drop down list listing the vendor's locations, etc.) allows a vendor to easily track pulled-promotions. For example, a vendor can track all pulled-promotions offered for a particular product, all pulled-promotions offered at a particular location, and/or the like. In some embodiments, after the vendor has used the user interface controls to define the new pulled-promotion, the pulled-promotion description resulting from the user interface controls can be further refined by the user. For example, using the pre-populated fields, a text string describing the pulled-promotion can be displayed to and/or modified by the vendor. This allows a vendor to further customize the pulled-promotion to be seen by consumers while allowing the vendor to track the pulled-promotion based on the pre-populated values.

A vendor can also send coupons to a user using targeted advertisements (e.g., pushed-promotions). As used herein, targeted advertisements can include any coupons, advertisements and/or deals that can be sent (e.g., pushed) to the user by the vendor using the rewards program application. A vendor can use targeted advertisements to send coupons and/or advertisements, and/or deals to a specific group of potential customers. For example, a vendor can select to send a coupon, advertisement and/or deal to all subscribers of the rewards program application within a specific geographic area, that fit a particular demographic profile (e.g., all males, all students at a particular university, all high school seniors, all users employed by a particular company, all users having a particular profession), based on a user's preference, that are member's of the vendors loyalty program, based on a consumer's loyalty program level (described in further detail herein), and/or the like. For example, a pizzeria can initiate a targeted coupon to be sent to each subscriber of the rewards program application that has indicated that they enjoy pizza. Such a targeted coupon can be further targeted by the vender indicating that they only wish to send the coupon to subscribers that work for a particular employer (e.g., that may be in a same geographic area as the pizzeria). In some embodiments, the vendor can elect to send such targeted advertisements to those subscribers of the rewards program application that are not members of that vendor's loyalty program (e.g., a subscriber that is a member of another vendor's loyalty program) as well as those subscribers of the rewards program application that are members of their vendor's loyalty program, as long as such subscribers fit the established criteria for the targeted advertisement. As such, a vendor can send targeted advertisements to users of the rewards program application that are not subscribers to that vendor's loyalty program. This allows a vendor to reach prospective customers (e.g., those users of a specific demographic not already subscribers of that vendor's loyalty program) using targeted advertisements.

In some embodiments, a targeted advertisement can be a recurring advertisement. For example, a vendor might define a coupon to be sent to a subscriber of their loyalty program on their birthday each year. Additionally, in some embodiments, a targeted advertisement can be sent to a subscriber as a result of an action taken by the subscriber. For example, the vendor can define a coupon to be sent to a subscriber if the subscriber refers a friend to the vendor's loyalty program.

In some embodiments, a vendor can be charged for a targeted advertisement based on a number of subscribers to which the targeted advertisement will be sent. Similarly stated, the vendor can be charged for a targeted advertisement based on a number of users in the targeted audience. For example, a vendor can be charged more for a broad targeted advertisement (e.g., all males) than a narrower targeted advertisement (e.g., all males that enjoy pizza within 10 miles of an address of a pizzeria).

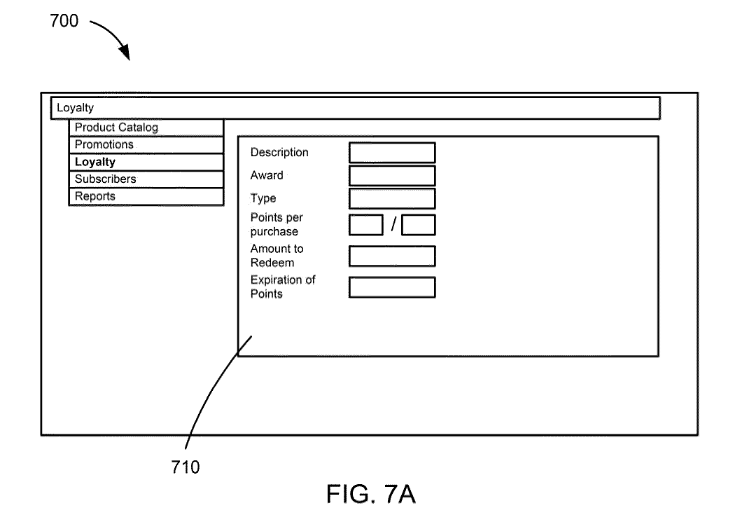

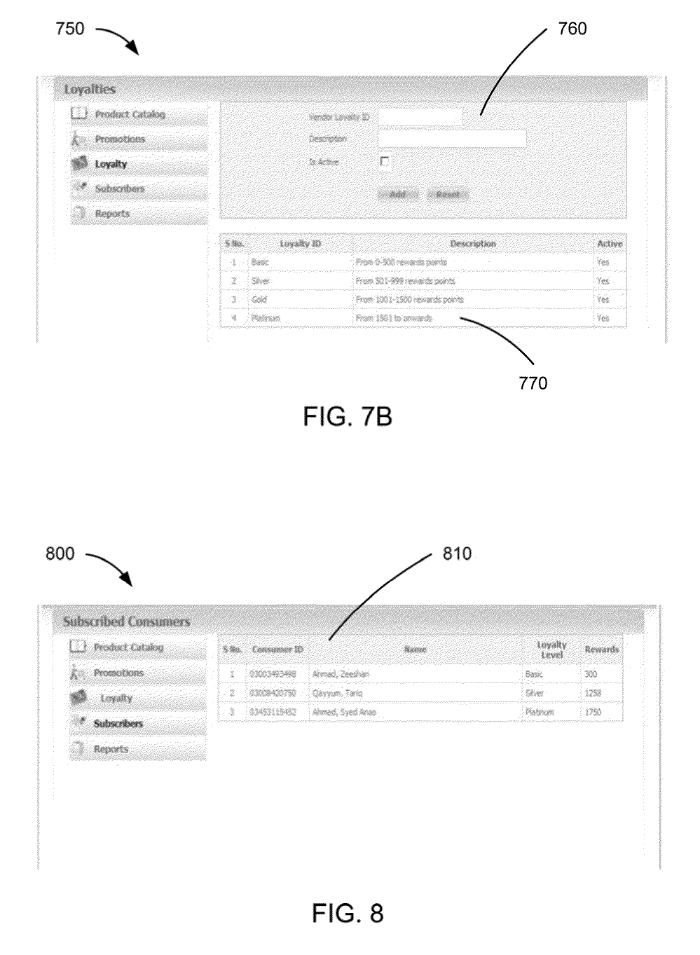

FIG. 7A is a loyalty program initiation screen 700 of a rewards program management application. A vendor can use the loyalty program initiation screen 700 to define and/or initiate a loyalty program. A loyalty program, as used herein, can include a program in which a subscriber accumulates points for purchases made at a vendor. Such points can be redeemed towards a future discount and/or coupon.

As shown in FIG. 7A, a vendor can provide, using a form 710, a description of the loyalty program, an award associated with the loyalty program, a type of the loyalty program, a number of points a subscriber will accumulate per purchase, a number of points for a subscriber to redeem their reward points, and an expiration of the subscriber's reward points. The description of the loyalty program can be a text description and/or title of the loyalty program provided by the vendor. For example, the description of the loyalty program for a pizzeria can be “buy 10 pizzas, get one free,” “Pizzeria Loyalty Program,” or any other description and/or title of the loyalty program. The award associated with the loyalty program can be a product and/or service that a subscriber of the loyalty program can obtain (either free or at a discount) by participation in the loyalty program. For example, the award can be a “large one-topping pizza” for a pizzeria's loyalty program.

In some embodiments, the type of loyalty program can be either spending or item based. If a vendor defines a spending based loyalty program, a subscriber can receive a redeemable coupon for an award when the subscriber has spent a predetermined amount of money at the vendor. For example, a loyalty program at a pizzeria can offer a subscriber a free large pizza for every $100 the subscriber spends at the pizzeria. If a vendor defines an item based loyalty program, a subscriber can receive a redeemable coupon for the award specified by the vendor when the subscriber has purchased a predetermined number of items from the vendor. For example, a loyalty program at a pizzeria can offer a subscriber a free large pizza for every ten large pizzas purchased.

In some embodiments, a vendor can define and/or specify a number of points a subscriber can be awarded for each purchase. For example, in a spending based loyalty program, a vendor might specify that for every $10 spent, a subscriber is awarded a reward point. For another example, in an item based loyalty program, a vendor might specify that for every pizza purchased at the vendor, a subscriber is awarded a reward point. In some embodiments, a vendor can assign different point values for different purchases. For example, in an item based loyalty program, a vendor might specify that for each small pizza purchased, a subscriber is awarded one reward point; for each medium pizza purchased, the subscriber is awarded two reward points; and for each large pizza purchased, the subscriber is awarded three reward points. For another example, in a spending based loyalty program, a vendor might specify that for every $10 spent in a single transaction, a subscriber is awarded one reward point; for every $20 spent in a single transaction, the subscriber is awarded three points; and for every $30 spent in a single transaction, the subscriber is awarded six points. In such embodiments, the vendor can use their loyalty program to encourage subscribers to make greater purchases.

In some embodiments, a vendor can define different levels within a loyalty program. FIG. 7B, for example, shows a loyalty level screen 750 of a rewards program management application. The loyalty level screen 750 allows a vendor to define (using the form 760) and/or view (using the chart 770) various levels of loyalty (e.g., basic, silver, gold, platinum). In some embodiments, the loyalty levels can be based on a number of rewards points earned by a user. In such embodiments, rewards points can be earned when purchases are made by the user from the vendor. After a user purchases an amount of goods from the vendor, their loyalty level can be increased.

In some embodiments, a vendor can send different coupons to members of its rewards program based on the loyalty levels of the members. For example, the coupons sent to platinum members might be more valuable than those sent to basic members. More specifically, the vendor can use loyalty level within a rewards program as criteria when sending targeted advertisements. Additionally, the vendor can offer additional perks and/or benefits for various levels of loyalty. For example, after a user becomes a platinum loyalty member, the vendor might give the user 10% off everything purchased.

FIG. 8 shows a subscriber screen 800 of a rewards program management application. The subscriber screen lists the subscribers and/or members of a vendor's rewards program in a chart 810. Additionally, the subscriber screen lists each subscriber's loyalty level and the number of rewards points that each user has accumulated. This screen allows a vendor to monitor and identify their customers.

In other embodiments, the chart 810 does not contain personally identifiable information of the subscribers of the vendor's loyalty program. In such embodiments, the chart 810 lists only demographic information of the subscribers. Such demographic information can include, for example, a sex of the subscriber, an age (or age range) of the subscriber, an income level of the subscriber, a location of the subscriber, an employer of the subscriber, a marital status of the subscriber, preferences of the subscriber, and/or the like. Such information can allow a vendor to track the demographics of their customers. In still other embodiments, such demographic information is not displayed for each subscriber, but is aggregated in a chart such that the vendor can view an aggregated view of their subscribers but can not view the demographic information on a per subscriber basis. In such embodiments, a vendor can monitor the demographics of their most profitable customers while not obtaining demographic information on a per user basis.

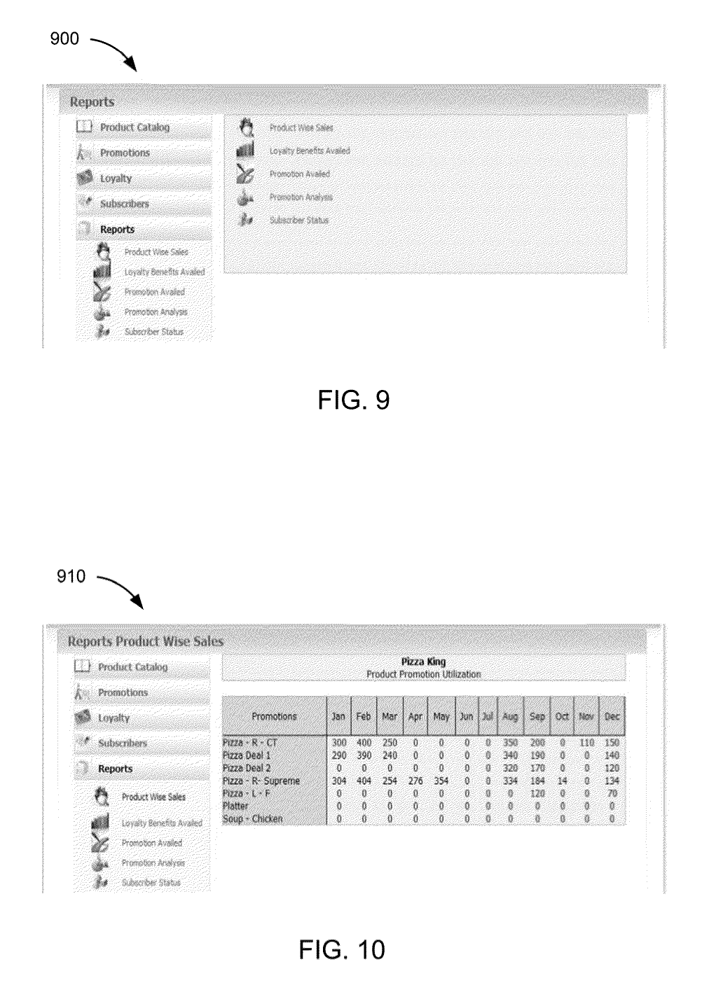

FIG. 9 shows a reports screen 900 of a rewards program management application. The reports screen 900 allows a vendor to select from various reports shown in greater detail in FIGS. 10-14. The reports allow a vendor to easily view, monitor and track the purchasing habits and marketing value of the members of the vendor's rewards program. As such, the vendor can determine which promotions are working, the demographics of their most profitable customers and/or the like.

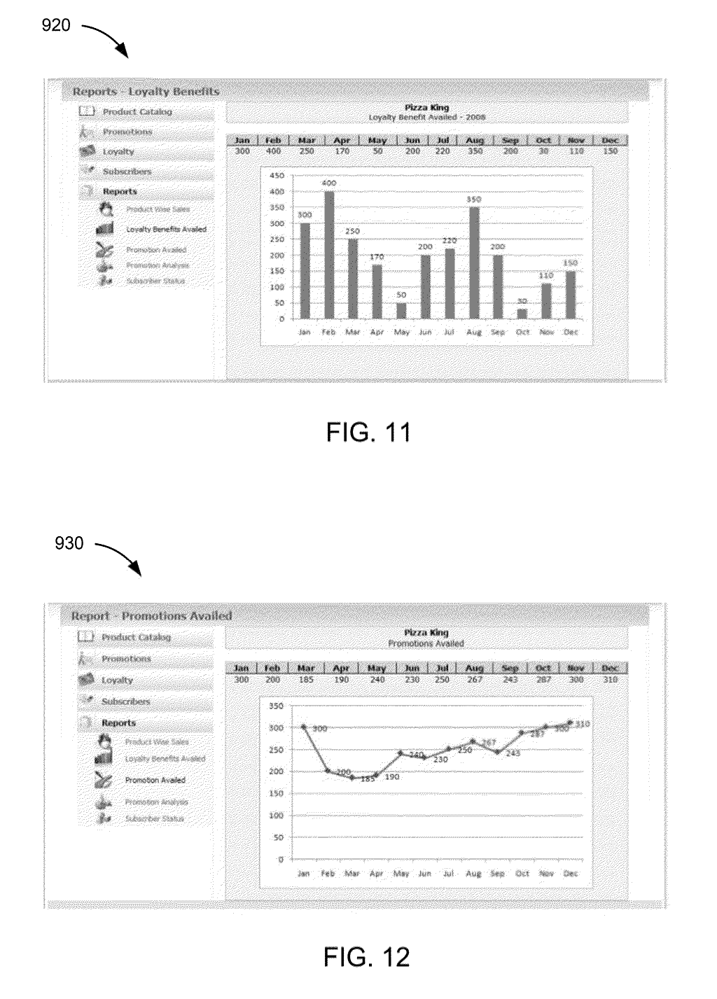

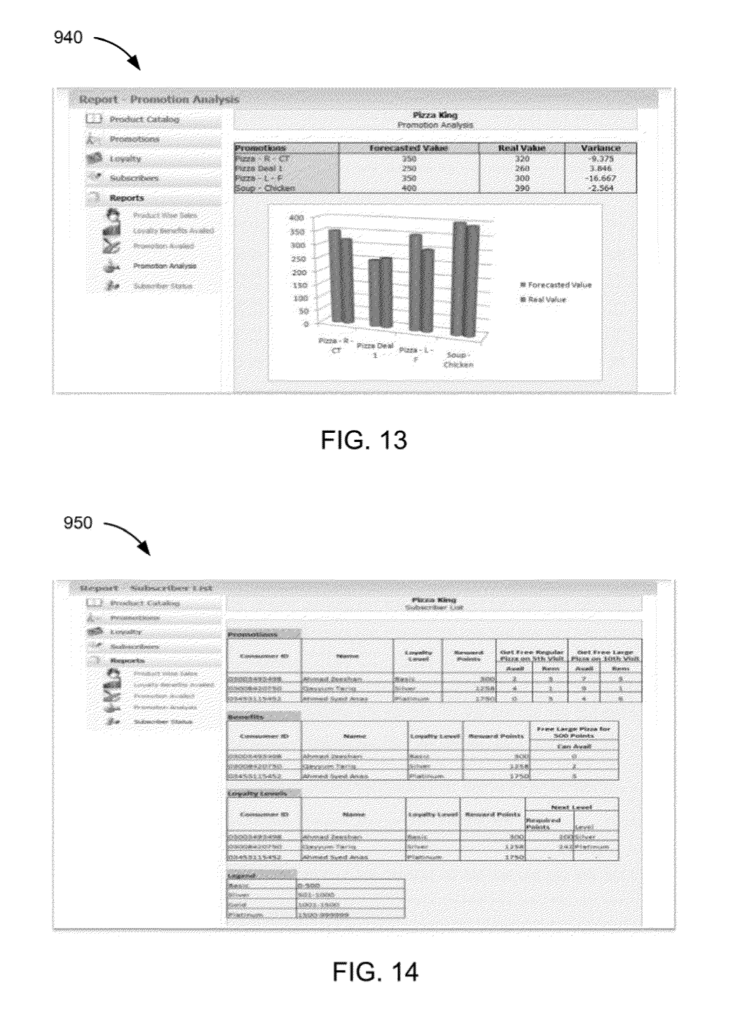

FIG. 10 shows a product wise sales report 910 that lists the promotions along with the number of sales using each promotion. This allows a vendor to monitor which promotions are being used and when the promotions are being used. Similarly, FIG. 11 shows a loyalty benefits report 920 that lists the loyalty benefits used in a bar chart format. This allows a vendor to monitor the number of loyalty benefits the rewards program members use and when the loyalty benefits are used. FIG. 12 shows a promotions availed graph 930 that shows a trend of the promotions and/or targeted advertisements and coupons used by customers. Using the promotions availed graph 930, a vendor can determine the effectiveness of their promotions and/or targeted advertisements. FIG. 13 shows a promotions analysis screen 940 that displays a comparison of a real value of a promotion (e.g., based on the number of promotions availed) with a forecasted value of the promotion.

FIG. 14 shows a subscriber status report 950 that shows the status of each subscriber of a vendor's rewards program. For example, the subscriber status report 950 shows the promotions offered to each member and the number of promotions redeemed. The subscriber status report also shows the loyalty levels of each member of the rewards program. Similar to the chart 810 described above with respect to FIG. 8, in other embodiments, such a subscriber status report does not include personally identifiable information. In such embodiments, the subscriber status report 950 lists non-personally identifiable demographic information of each subscriber.

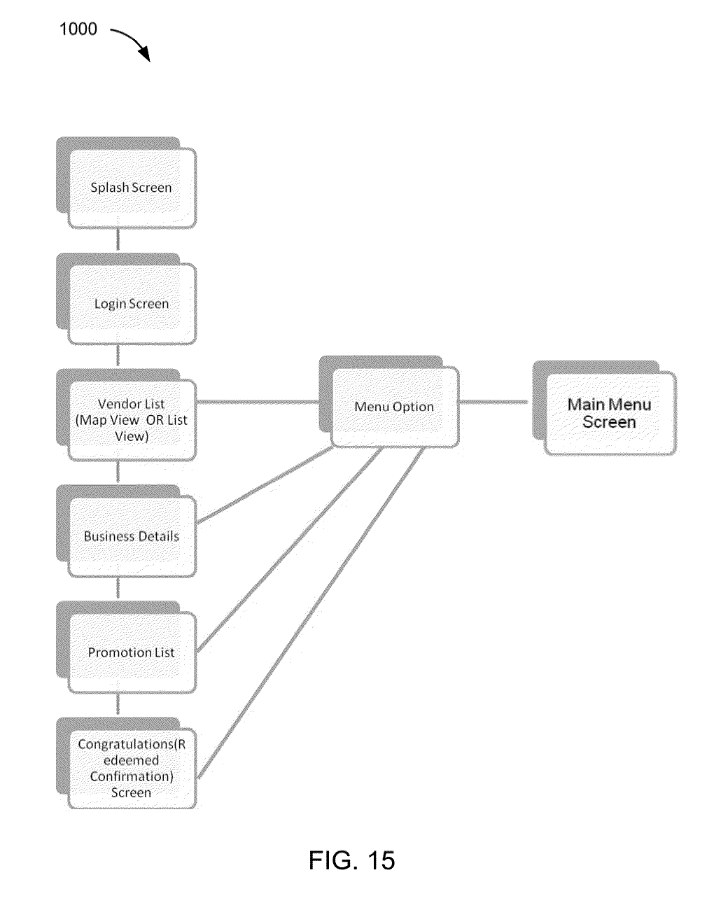

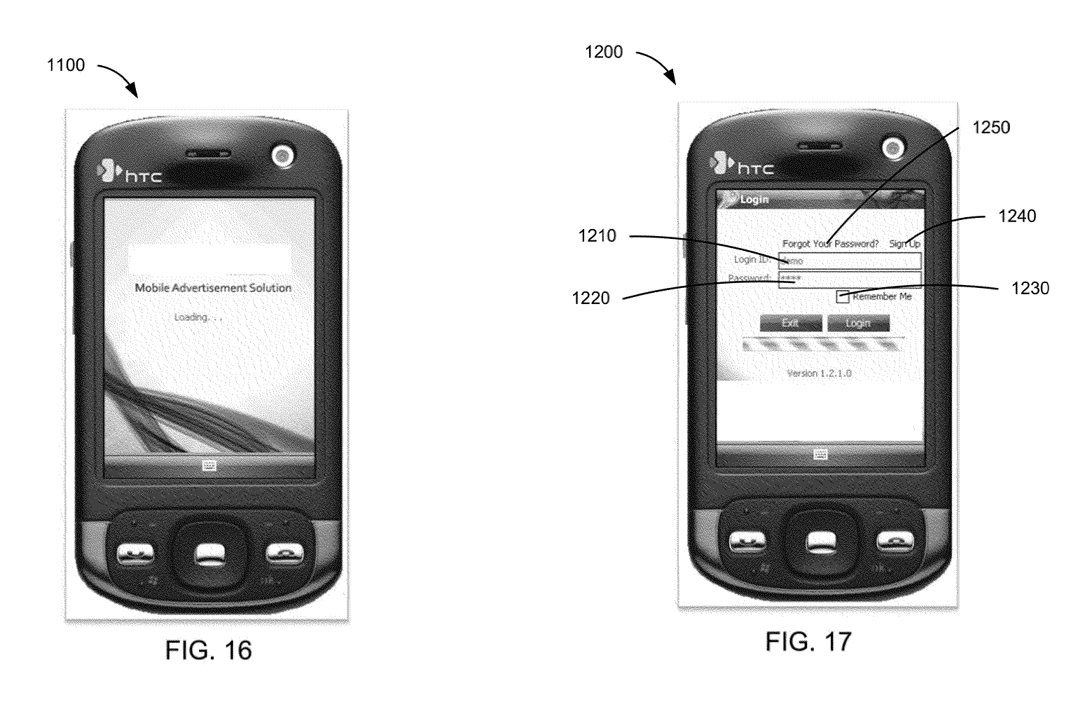

FIG. 15 is a screen flow diagram 1000 illustrating the screens viewable by a user of a rewards program application, according to another embodiment. Such screens are shown and described in further detail with respect to FIGS. 16-27. In some embodiments, the rewards program application is running on a communication device (e.g., communication device 150 or communication device 160, shown and described in FIG. 1A). As such, the rewards program application can access data stored in a memory of a host device. Additionally, the rewards program application can send data to and receive data from the host device.

FIG. 16 shows a splash screen 1100 of a rewards program application that is displayed on the communication device after a user indicates to the communication device to run the rewards program application. The splash screen can be displayed, for example, while the communication device is loading the rewards program application.

FIG. 17 shows a login screen 1200 of a rewards program application. A user can enter a user name and password in the provided textboxes 1210, 1220, respectively, to access data associated with their account on the rewards program application. The user name and password can be authenticated by a host device (e.g., host device 120) to allow a user to access the data. As discussed above, the data associated with the rewards program application and the data associated with the user (e.g., their preferences) can be stored in a memory of the host device. In some embodiments, a “remember me” check-box 1230 can be selected such that a user's user name and password are remembered and the user is automatically logged in the next time the application is started. In some embodiments, the login screen can also include a “sign up” link 1240 that allows a user to initiate an account with the system and/or a “forgot your password?” link 1250 that allows a user to retrieve a lost password.

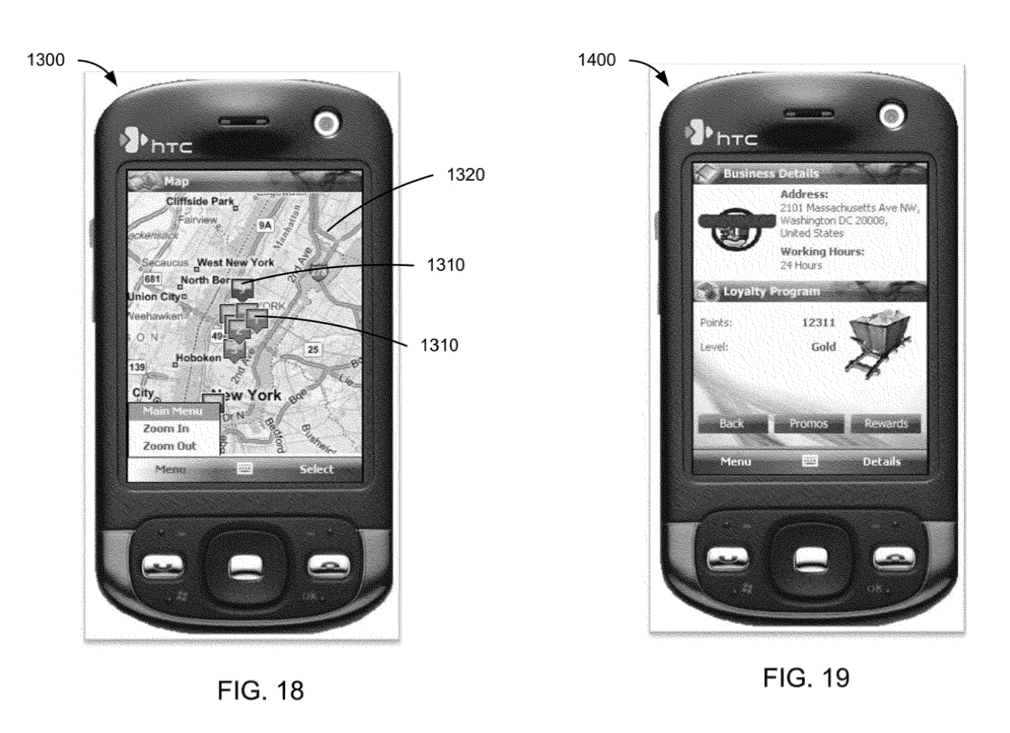

FIG. 18 is a map screen 1300 showing vendors within a geographic area. Using the map screen, a user of the rewards program application can search for vendors within a geographic area having promotions, loyalty programs, specific products and/or services, advertisements, and/or the like. For example, a user can use the map to search for vendors having loyalty and/or rewards programs within a geographic area. The location of such vendors can be represented by icons 1310 on a map 1320 of the geographic area. As discussed in further detail herein, by selecting the icon 1310 associated with a vendor, the user can view details associated with the vendor and their loyalty program. Using the map screen 1300, a user can search for vendors within a geographic area with which they may not be familiar. Additionally, the user can view the promotions offered by the vendor, view the details of the vendor's loyalty program, view a product list of the vendor, call the vendor, view an address of the vendor, sign up for the vendor's rewards program and/or the like.

In some embodiments, the communication device includes a location tracking system such as a global positioning system (GPS) and/or uses cell phone triangulation techniques to determine a geographic location of the communication device. Using the geographic location, the rewards program application (e.g., in communication with a host device such as host device 120) can display the search results (e.g., the vendors with loyalty programs in the geographic area) as icons 1310 on the map 1320. In other embodiments, a user can search for vendors using a zip code, street address, city name, state name, a telephone area code, a geographic radius within which to search, and/or any other indication of the geographic area the user wishes to search.

In some embodiments, an indication can be displayed to differentiate the vendors displayed on the map that include a rewards program with which the user is a member from the vendors displayed on the map that include a rewards program with which the user is not a member. For example, a first color (e.g., red) can represent vendors with a rewards program with which the user is a member and a second color (e.g., green) can represent vendors with a rewards program with which the user is not a member. In other embodiments, any other indication, such as a different icon, a different boarder, a different shading and/or the like can be used to differentiate the vendors. As discussed above, the user can click on a vendor having a rewards program with which they are not yet a member and become a member.

While described above as using location based criteria to search for a vendor, in some embodiments a user of a communication device can search for vendors using any suitable criteria for example, a type of vendor, a cost of the vendor, a number and/or type of coupons offered by the vendor, and/or the like. Additionally, while shown and described as displaying vendors on a map, in some embodiments, identifiers associated with a set of vendors can be displayed to the user of the communication device in any suitable manner. For example, a list of vendors meeting and/or matching a search criteria can be displayed on the communication device using a list. In such embodiments, for example, a list having all pizza vendors within a 10 mile radius of the user can be displayed to the user in response to the user searching for all pizza vendors within a 10 mile radius.

Moreover, in some embodiments, a user of a communication device can sort and/or filter a list of vendors using any suitable criteria. For example, after a list and/or map of vendors is displayed to a user, the user can sort and/or filter the results using additional criteria, such as, listing the vendors in alphabetical order, only displaying the vendors with a current promotion, only displaying the vendors with a loyalty program, listing the vendors according to location (e.g., distance to), only displaying the vendors within a geographic radius, and/or the like.

FIG. 19 is a business details screen 1400 that lists details associated with a particular vendor. In some embodiments, the business details view is displayed when a user selects an icon 1310 associated with one of the vendors shown on the map 1320 of FIG. 18. In other embodiments, a user can have the business details screen 1400 of a vendor bookmarked (e.g., in a list of favorite vendors), can select the business details screen 1400 of a vendor from a list of nearby vendors and/or the like.

The business details screen 1400 displays information about the selected vendor. In some embodiments, for example, the business details view displays a logo of the vendor, an address of the vendor's location, a phone number of the vendor, the working hours of the vendor, directions to the vendor's location, user reviews of the vendor, a product list of the vendor (e.g., a menu for a restaurant) and/or the like. The business details view also includes a link to view a list of promotions offered by the vendor, a link to a list of rewards (e.g., from a rewards program) offered by the vendor and a link to return to the previous screen (e.g., the map view, a list of vendors and/or the like). In some embodiments, the user can call the vendor by selecting a link associated with the phone number of the vendor. In some embodiments, the user can view directions to the vendor's location by selecting a link associated with the address of the vendor's location.

In some embodiments, a user can select items from the product list and order them using the communication device. For example, a user can select items from a restaurant's menu and place an order using the communication device. After the user selects the items, a signal is sent to the host device indicating the selection. The host device can then send a signal to the vendor indicating the user's order. In some embodiments, the vendor sends a confirmation signal to the communication device of the user via the host device. Such a confirmation signal can indicate, for example, when the user's order can be picked up.

Additionally, if the user is a member of the vendor's rewards and/or loyalty program, the business details view can display data associated with the rewards and/or loyalty program. For example, the business details view can display a number of rewards points that the user has earned, a loyalty level of the user, and/or the like. In some embodiments, if the user is not already a member of the vendor's rewards and/or loyalty program, the business details view can include a link allowing the user to sign up for the rewards and/or loyalty program and/or additional information about the rewards and/or loyalty program.

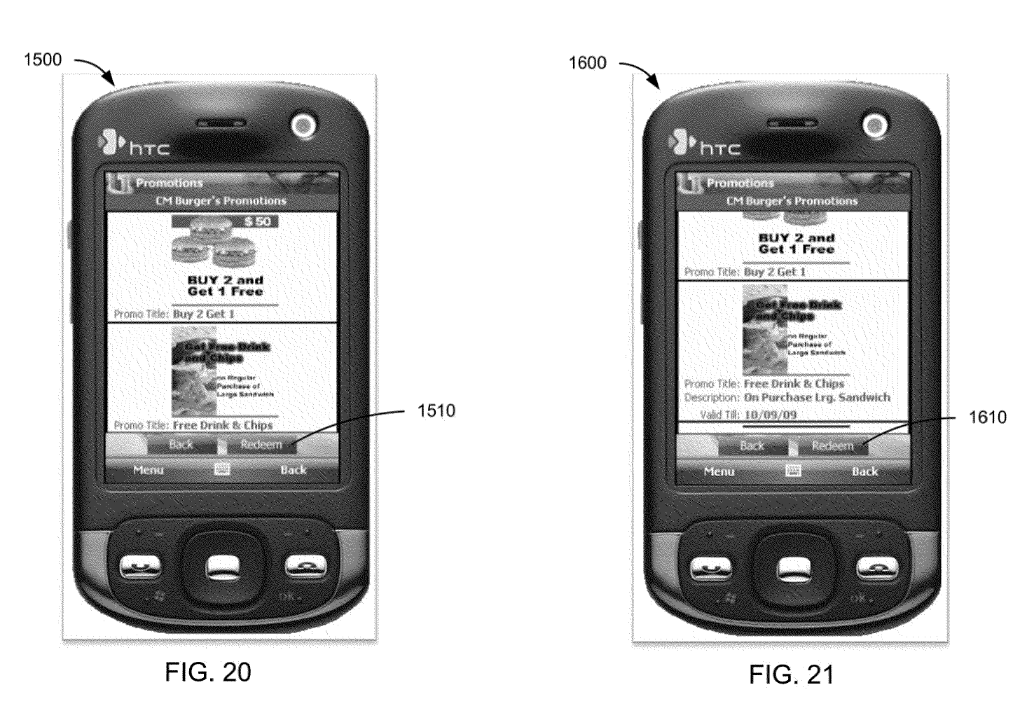

FIG. 20 is a promotion list screen 1500 for a vendor. The promotion list screen 1500 displays the promotions available to the user from the vendor. In some embodiments, the user can, for example, access the promotion list screen 1500 from the business details screen 1400 associated with the vendor. As discussed above, the promotions available to a user can be dependent on the loyalty level of the user (e.g., the number of rewards points a user has), the location of a user, the previous promotions that the user has redeemed, and/or the like. In some embodiments, the promotions are not dependent on whether a user is a rewards member and any user can view and redeem the promotion. In other embodiments, the promotions available to a user depend on whether or not the user is a rewards member. In such embodiments, for example, a user who is not a rewards member can have access to promotions designed to entice him to become a rewards member while a user who is a rewards member can have access to promotions designed to retain him as a loyal customer. As discussed herein, in some embodiments, the promotions available to a user depend on the loyalty level (e.g., basic, silver, gold, platinum) of the user.

FIG. 21 is a selected promotion screen 1600. The selected promotion screen 1600 can be displayed in response to the user selecting a specific promotion. The detailed view can include additional information associated with the promotion such as, for example, a time period during which the promotion is valid (e.g., an expiration date, a date range, a specific date, a specific time, and/or the like), a description of the promotion and/or the like.

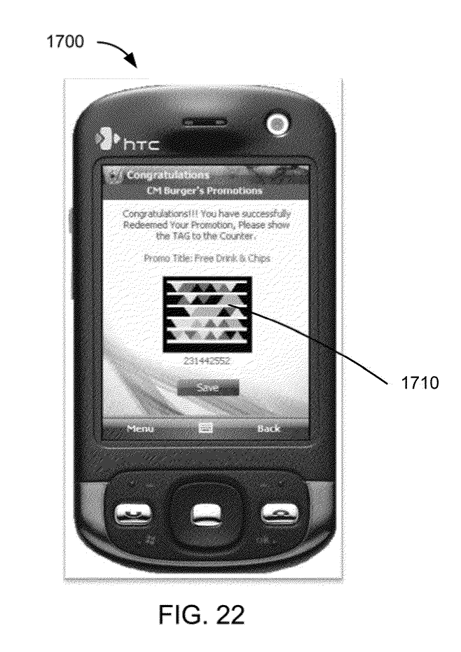

The promotion list screen 1500 and/or the selected promotion screen 1600 can include a link 1510, 1610, respectively, that allows a user to redeem the promotion. When a user selects the link, a signal is sent from the communication device to the host device indicating that the user wishes to redeem the promotion. In response to receiving the signal, the host device can send a signal to the communication device indicating that the promotion can be redeemed. The signal sent to the communication device can cause the communication device to display a bar code on the display of the communication device, as shown in FIG. 22. In other embodiments, a confirmation number and/or any other information that can be used by the vendor to identify the user as redeeming a valid promotion can be displayed on the communication device in response to receiving the signal from the host device. In other embodiments, the host device can also send a signal to the vendor indicating that the user intends to redeem the promotion.

FIG. 22 shows a redemption screen 1700 indicating that the user has successfully redeemed the promotion and/or coupon. FIG. 22 shows a promotion barcode 1710 that can be presented to and scanned by the vendor. In some embodiments, the barcode 1710 can be, for example, a high capacity color barcode (e.g., a Microsoft TAG Image), a QR code, a one-dimensional barcode, and/or the like. In other embodiments, any other type of barcode can be used. In some embodiments, the barcode image is generated by the host device and sent to the user's communication device in real-time. In other embodiments, a unique identifier is provided to a user to redeem the promotion. Such a promotion barcode can be dynamically generated each time a user is provided a promotion and/or targeted advertisement. The promotion barcode 1710 and/or the unique identifier can encode and/or identify multiple parameters used to track a user's use and/or activity with respect to a promotion. For example, the promotion barcode 1710, associated with the promotion and/or coupon, can encode and/or identify information associated with the promotion and/or coupon, the user, a location of the vendor at which the promotion is valid, an expiration date of the promotion and/or coupon, a unique identifier associated with that instance of the promotion and/or coupon, and/or the like. For example, a rewards program management application can identify the promotion and the user based on the promotion barcode 1710 and/or the identifier.

To redeem the promotion and/or coupon, the user can present the promotion barcode 1710 to the vendor. The vendor can scan the promotion barcode 1710 using any suitable device. In some embodiments, for example, the vendor can use a promotion barcode scanner device (e.g., a DCD) to scan the promotion barcode 1710. In other embodiments, the vendor can use a mobile telephone having barcode scanning software and/or hardware installed. In still other embodiments, the vendor can input the unique identifier into a device to indicate that the user has redeemed the promotion.

After a vendor scans the user's promotion barcode 1710 (or performs another action indicating that the transaction involving the promotion has occurred), the communication device of the vendor can send a signal to the host device indicating that the user redeemed the promotion. Such a signal can include information associated with the promotion and/or coupon, and/or the user's redemption of the promotion and/or coupon. For example, the signal can include a promotion identifier (e.g., from the promotion barcode), a location at which the user redeemed the promotion, a time at which the user redeemed the promotion, an identifier of the user (e.g., from the promotion barcode), and/or the like. Using the signal, the host device can update the vendor's rewards program management application account. Accordingly, the vendor can be supplied with feedback regarding the user's use of the promotion and/or targeted advertisement. For example, the vendor and the user can view that the transaction has occurred using the rewards program management application and the rewards program application, respectively. In some embodiments, the information is available to other interested parties, such as, for example, banks, advertising researchers, and/or any other party having access to the data of the vendor's rewards program. In such embodiments, for example, financing might be dependent on a bank's approval. Such an embodiment allows the bank to receive an indication of the transaction substantially simultaneous to the transaction occurring.

As discussed above, in some embodiments, the vendor's communication device can include a mobile telephone and/or another barcode scanner device. In such embodiments, the vendor does not need a point of sales system that is connected to a network. The vendor can use the mobile telephone after the barcode is scanned to send a message to the host device that the transaction associated with the promotion has occurred. In some embodiments, the image of the promotion barcode can be sent from the communication device to the host device. In other embodiments, the vendor is given a code to send to the host device that indicates the transaction has occurred.

In some embodiments, the user can save the promotion barcode prior to the vendor scanning the promotion barcode. This allows a user to present the promotion barcode to the vendor at a time after the user redeemed the promotion. As such, the user can recall the promotion barcode at a latter time to present it to the vendor.

In some embodiments, instead of a barcode, the user can pay directly from their communication device. In such embodiments, the payment is processed by the host device when the user selects the “redeem” link and the communication device sends a signal to the host device. Payment can occur using a credit card, a bank account number, an online payment service (e.g., PayPal) and/or using any other suitable means. Accordingly, depending on the purchase, the user can pick up the purchased item at a latter time at the vendor's location, the vendor can send the purchased item to the user (e.g., through mail and/or electronic means) and/or the like.

While FIG. 22 illustrates a promotion barcode a user can present to a vendor to redeem a promotion, in some embodiments, a similar barcode and/or identifier can be used and/or presented to a vendor to indicate a user's participation in that vendor's loyalty program. Such a loyalty program barcode and/or identifier can be provided and/or sent to a communication device of a user in response to that user subscribing to the vendor's loyalty program. As such, the loyalty program barcode can be dynamically generated in response to the user subscribing to the vendor's loyalty program. Such a loyalty program barcode and/or identifier can encode and/or identify multiple parameters used to track a user's use and/or activity with respect to a loyalty program. In some embodiments, the multiple parameters encoded and/or identified by the loyalty program barcode can be different from the multiple parameters encoded and/or identified by a promotion barcode (described above with respect to FIG. 22). For example, a loyalty program barcode can encode and/or identify an identifier of the loyalty program and an identifier of the user. Each time the user purchases a product and/or service from that vendor, the user can present the loyalty program barcode to the vendor to scan. The identifier of the loyalty program and the identifier of the user can be sent from the vendor (e.g., from a barcode scanner) to the host device in response to scanning the barcode. Based on the identifier of the loyalty program and the identifier of the user, the host device can add a reward point to the user's loyalty program account associated with that vendor.

In some embodiments, additional information can be sent from the vendor to the host device in response to scanning the loyalty program barcode. For example, a time of the scan, a location of the scan, and/or the like. Additionally, the vendor can provide other information to be sent and recorded by the host device such as, for example, an item and/or service purchased by the user, an amount of money spent by the user, a number of award points to award to the user, and/or the like. In other embodiments, the vendor scans the loyalty program barcode once for every point to be awarded to the user.

In some embodiments, the loyalty program identifier is an identifier that the rewards program application associates with that user. For example, the loyalty program identifier can be a user's telephone number, address, and/or other identifier that can uniquely identify the user. In such embodiments, when a vendor provides a rewards program management application with the user's identifier, the rewards program management application can identify the sending vendor and update the user's loyalty account with that vendor accordingly.

In some embodiments, a third type of barcode can be provided and/or sent to a user of a communication device when the user redeems and/or is provided a reward (e.g., coupon) associated with a loyalty program. Such a reward barcode can be dynamically generated each time a user requests to redeem their loyalty points. The reward barcode and/or identifier can encode and/or identify multiple parameters used to track a user's use and/or activity with respect to a reward from a loyalty program. In some embodiments, the multiple parameters encoded and/or identified by the reward barcode can be different from the multiple parameters encoded and/or identified by a loyalty program barcode and/or a promotion barcode (described above with respect to FIG. 22). For example, parameters of a reward barcode can include an identifier of a user, an expiration date of a loyalty reward, an identifier of a location at which the loyalty reward is valid, an identifier of the loyalty program, an indicator of the loyalty reward, and/or the like. For example, a rewards program management application can identify the reward associated with the loyalty program, the loyalty program and the user based on the reward barcode and/or identifier. Similar to the promotion barcode, to redeem the reward associated with the loyalty program, the user can present the reward barcode to the vendor. The vendor can scan the reward barcode using any suitable device.

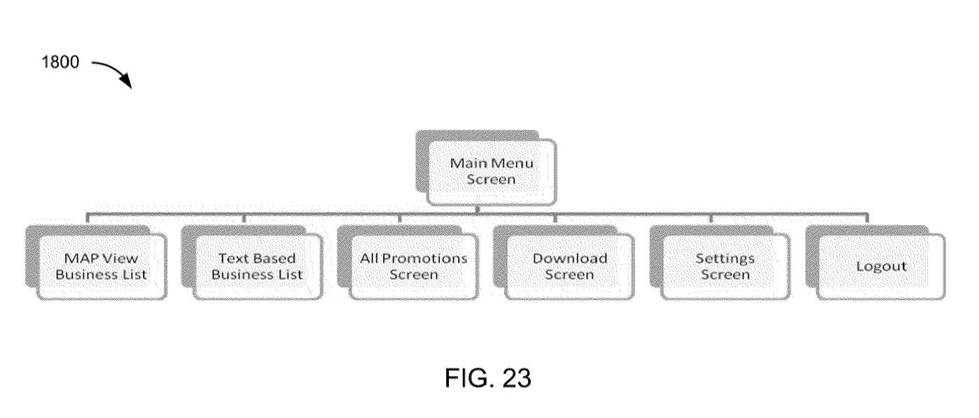

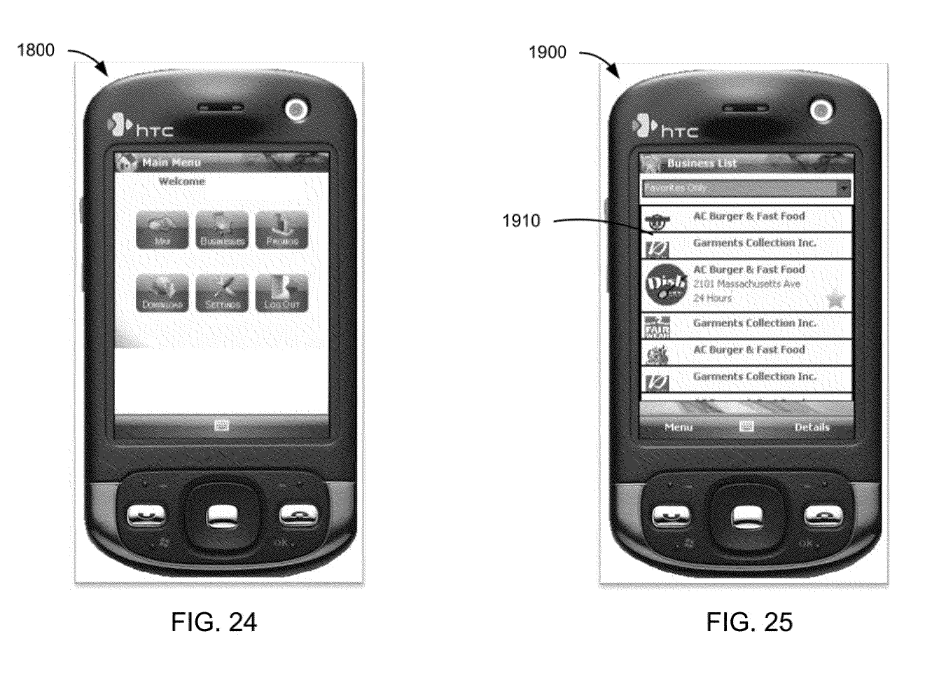

FIG. 23 is a screen flow diagram 1800 illustrating the screen flow of a main menu screen 1800 (see FIG. 24). The details of each of the screens is shown and described in further detail with respect to FIGS. 24-26.

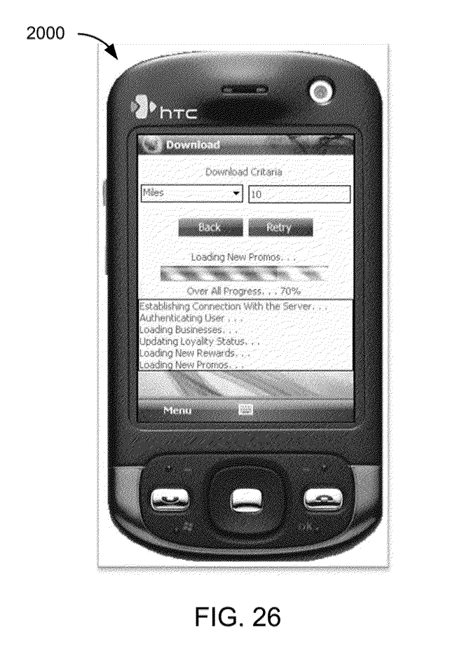

FIG. 24 shows the main menu screen 1800. In some embodiments, the main menu screen 1800 includes links to the map screen 1300 (FIG. 18), the business list screen 1900 (FIG. 25), a promotions screen (not shown) that displays all promotions from all vendors in a specific category (e.g., type, location, price, etc.), a download screen 2000 (FIG. 26) that allows a user to download new promotions from vendors via the host device based on specified criteria (e.g., type, location, price, vendor, etc.), a settings screen (not shown) that allows a user to customize the appearance and operation of their specific rewards program application and a logout link that logs the user out and displays the login screen (FIG. 17). In other embodiments, the main menu screen 1800 can include links to other screens such as, for example, a favorites screen that shows the users most visited vendors, a promotions redeemed screen that shows all of the promotions the user previously redeemed, and/or the like.

FIG. 25 shows a business list screen 1600 of a rewards program application. The business list screen 1600 includes a business list 1910 in which a user can view and/or browse businesses in a list format (as opposed to the map format of FIG. 18). The user can select criteria used to select the businesses to view. For example, the business list 1910 can be generated based on a favorites list, a history of promotions redeemed, a location, a type of vendor, vendors with which the user is a member of their rewards program and/or any other criteria. In some embodiments, when the user selects a vendor from the businesses list 1910, the business details screen 1400 (FIG. 19) can be displayed.

FIG. 26 shows a download screen 2000 of a rewards program application. The download screen 2000 allows a user to download new promotions from the host device based on various criteria. In some embodiments, for example, the user can select to download promotions based on a location (e.g., a distance from a user's current location, a zip code, a city, etc.), an identifier associated with a business (e.g., a business ID number, a business name, etc.), a type of vendor, vendors with which the user is a member of their rewards program, an alphabetical listing, and/or any other criteria. After the promotions are downloaded, vendors with new downloaded promotions can be displayed in a list and/or on the map view (FIG. 18).

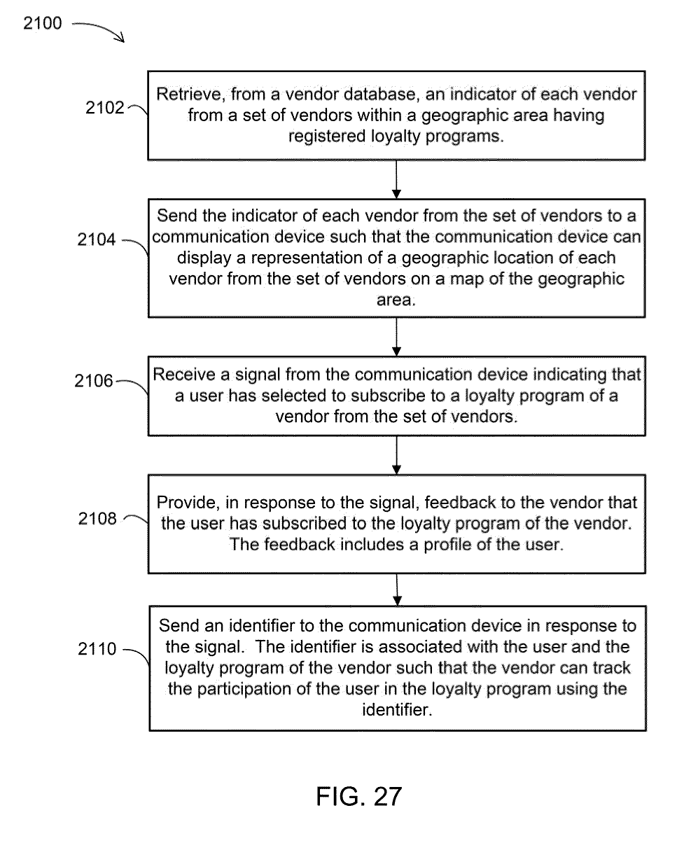

FIG. 27 is a flow chart illustrating a method 2100 of searching for and enrolling in a vendor's loyalty program. The method 2100 includes retrieving, from a vendor database, an indicator of each vendor from a set of vendors within a geographic area having registered loyalty programs, at 2102. An indication of the geographic area can be provided by a zip code, street address, GPS signal indicating a location of a communication device, cell phone triangulation indicating a location of the communication device, and/or the like.

The indicator of each vendor from the set of vendors is sent to a communication device such that the communication device can display a representation of a geographic location of each vendor from the set of vendors on a map of the geographic area, at 2104. For example, icons indicating a location of each vendor can be displayed on a map on the communication device. Such a map and icons can be similar to the map 1320 and the icons 1310 shown and described with respect to FIG. 18.

A signal is received from the communication device indicating that a user has selected to subscribe to a loyalty program of a vendor from the set of vendors, at 2106. Feedback is provided to the vendor that the user has subscribed to the loyalty program of the vendor, in response to the signal, at 2108. In some embodiments, the feedback can include a profile of the user that subscribed to the vendor's loyalty and/or rewards program. Such a profile can include demographic information (e.g., sex, age, geographic location, economic information, etc.), preferences, and/or the like. In some embodiments, the profile includes personally identifiable information (e.g., name, address, telephone number, etc.). In other embodiments, the profile does not include personally identifiable information.

An identifier is sent to the communication device in response to the signal, at 2110. The identifier is associated with the user and the loyalty program of the vendor such that the vendor can track participation of the user in the loyalty program using the identifier. In some embodiments, the identifier can be a barcode that encodes an indicator that uniquely identifies the user, the vendor and/or the loyalty program.

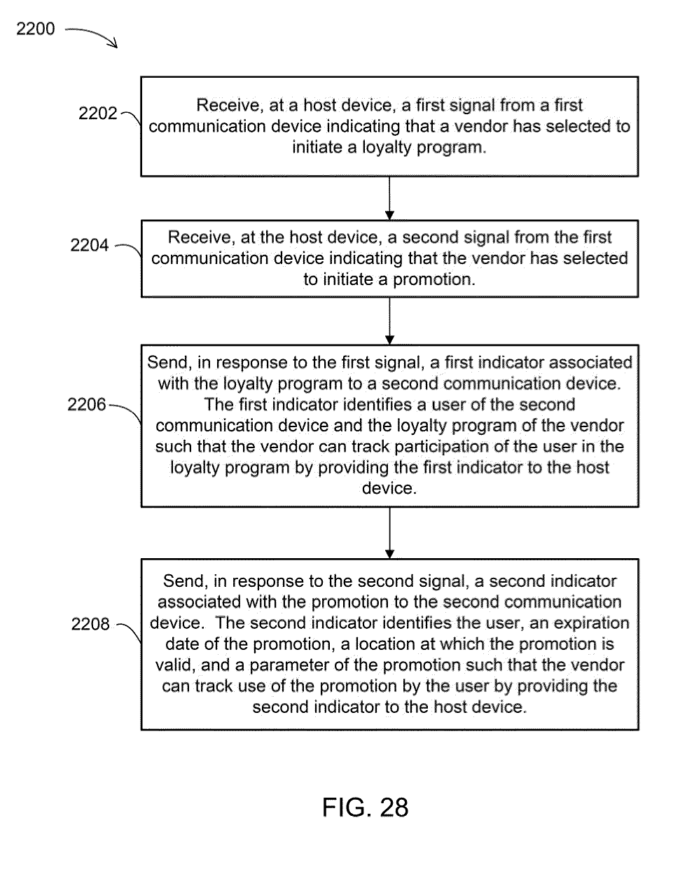

FIG. 28 is a flow chart illustrating a method 2200 of initiating a loyalty program and a promotion. The method 2200 includes receiving, at a host device, a first signal from a first communication device indicating that a vendor has selected to initiate a loyalty program, at 2202. A second signal is received from the first communication device, at the host device, indicating that the vendor has selected to initiate a promotion, at 2204. Such a communication device can be associated with the vendor and can be running and/or executing a rewards program management application that provides functionality to the vendor to define and/or initiate the loyalty program and the promotion.

A first indicator associated with the loyalty program is sent, in response to the first signal, to a second communication device, at 2206. The first indicator identifies a user of the second communication device and the loyalty program of the vendor such that the vendor can track participation of the user in the loyalty program by providing the first indicator to the host device. The second communication device can be running and/or executing a rewards program application that can display the first indicator. Accordingly, the vendor can provide the first indicator to the host device when the user presents the first indicator to the vendor. In such a manner, the user's participation in the loyalty program can be monitored.

A second indicator associated with the promotion is sent, in response to the second signal, to the second communication device, at 2208. The second indicator identifies the user, an expiration date of the promotion, a location at which the promotion is valid, and a parameter of the promotion such that the vendor can track use of the promotion by the user by providing the second indicator to the host device. Because the second indicator is associated with a promotion, rather than a loyalty program, the second indicator can contain different and/or additional types of information than the first indicator.

While various embodiments have been described above, it should be understood that they have been presented by way of example only, and not limitation. Where methods described above indicate certain events occurring in certain order, the ordering of certain events may be modified. Additionally, certain of the events may be performed concurrently in a parallel process when possible, as well as performed sequentially as described above.

In some embodiments, for example, a rewards program application can allow a user to sign up to receive premium benefits. In such embodiments, the user can pay a certain amount (e.g., $1/month subscription) to receive the premium benefits. The premium benefits can provide a user with more desirable promotions and/or coupons than a user who is not subscribed to receive premium benefits. For example, a user might pay $1/month to receive 10% off all purchases from a vendor and/or a group of vendors.

While shown and described above with respect to rewards programs and other promotions, the rewards program application can also be used to digitize and track gift cards. For example, a barcode and/or identifier associated with a gift card can be scanned and the balance maintained by the rewards program application (or at the host device). In such embodiments, a user can also purchase gift cards via the rewards program application. This provides the user an easy way to organize their gift cards while providing the vendor with helpful consumer data that can be used in future advertising.

In some embodiments, the system shown and described above can be integrated with other websites. For example, the system can be integrated to show user reviews displayed on user review websites such as Zagat, CitySearch, Yelp! and/or the like. In such embodiments, a user can read vendor reviews and/or write a vendor review using the rewards program application. In other embodiments, the system can also be integrated with social networking websites such as, for example, Facebook, MySpace, and/or the like. In such embodiments, users can share their favorite coupons and/or rewards programs with others. This helps facilitate viral marketing for the vendors.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

While various embodiments have been described above, it should be understood that they have been presented by way of example only, not limitation, and various changes in form and details may be made. Any portion of the apparatus and/or methods described herein may be combined in any combination, except mutually exclusive combinations. The embodiments described herein can include various combinations and/or sub-combinations of the functions, components and/or features of the different embodiments described.

What is claimed is:

1. A non-transitory processor-readable medium storing code representing instructions to cause a processor to:
retrieve, from a vendor database, an indicator of each vendor from a plurality of vendors within a geographic area having registered loyalty programs;
send the indicator of each vendor from the plurality of vendors to a communication device such that the communication device can display a representation of a geographic location of each vendor from the plurality of vendors on a map of the geographic area;
receive a signal from the communication device indicating that a user has selected to subscribe to a loyalty program of a vendor from the plurality of vendors; and
provide, in response to the signal, feedback to the vendor that the user has subscribed to the loyalty program of the vendor, the feedback including a profile of the user.

2. The non-transitory processor-readable medium of claim 1, wherein the signal is a first signal, the non-transitory processor-readable medium further comprising code representing instructions to cause the processor to:
receive a second signal indicating that the user has selected the vendor on the map; and
provide to the communication device, in response to the second signal, details associated with the loyalty program of the vendor.

3. The non-transitory processor-readable medium of claim 1, wherein the geographic area is selected based on a Global Positioning System signal associated with the communication device.

4. The non-transitory processor-readable medium of claim 1, wherein the geographic area is selected based on a location indicator entered by the user of the communication device.

5. The non-transitory processor-readable medium of claim 1, wherein the profile of the user includes at least one of demographic information of the user, geographic information of the user, user preferences, professional information of the user, or economic information of the user.

6. The non-transitory processor-readable medium of claim 1, further comprising code representing instructions to cause the processor to:
send a barcode to the communication device in response to the signal, the barcode encodes an identifier of the user and an identifier of the loyalty program of the vendor such that the vendor can track the participation of the user in the loyalty program by scanning the barcode.

7. The non-transitory processor-readable medium of claim 1, further comprising code representing instructions to cause the processor to:
send a first barcode to the communication device in response to the signal, the first barcode encodes an identifier of the user and an identifier of the loyalty program of the vendor such that the vendor can track the participation of the user in the loyalty program by scanning the first barcode; and
send a second barcode associated with a promotion to the communication device based on the profile of the user, the second barcode encodes the identifier of the user, an expiration date of the promotion, an identifier of a location at which the promotion is valid, and an identifier of a parameter of the promotion such that the vendor can track use of the promotion by the user by scanning the second barcode.

8. A non-transitory processor-readable medium storing code representing instructions to cause a processor to:
receive, at a host device, a first signal from a first communication device indicating that a vendor has selected to initiate a loyalty program;
receive, at the host device, a second signal from the first communication device indicating that the vendor has selected to initiate a promotion;
send, in response to the first signal, a first indicator associated with the loyalty program to a second communication device, the first indicator identifies a first set or parameters such that the vendor can track participation of a user of the second communication device in the loyalty program by providing the first indicator to the host device; and
send, in response to the second signal, a second indicator associated with the promotion to the second communication device, the second indicator identifies a second set of parameters, different from the first set of parameters, such that the vendor can track use of the promotion by the user by providing the second indicator to the host device.

9. The non-transitory processor-readable medium of claim 8, further comprising code representing instructions to cause the processor to:
receive, at the host device, a third signal from the first communication device indicating that the vendor has provided the first indicator to the host device;
increment a use counter associated with the user and the loyalty program;
compare the use counter with a redemption threshold; and
send a third indicator associated with a loyalty reward to the second communication device if the user counter is greater than the redemption threshold, the third indicator identifies a third set of parameters, different from the first set of parameters and the second set of parameters, the third set of parameters including at least one of an identifier of the user, an expiration date of the loyalty reward, an identifier of a location at which the loyalty reward is valid, an identifier of the loyalty program and a parameter of the loyalty reward such that the vendor can track use of the loyalty reward by the user by providing the third indicator to the host device.

10. The non-transitory processor-readable medium of claim 8, wherein a cost of the promotion to the vendor is associated with the expiration date of the promotion.

11. The non-transitory processor-readable medium of claim 8, wherein the promotion is provided to a plurality of members of the loyalty program.

12. The non-transitory processor-readable medium of claim 8, wherein the promotion is provided to a plurality of members of the loyalty program based on a geographic area of the plurality of members, demographic information of the plurality of members, a place of employment of the plurality of members, or a loyalty program level of the plurality of users.

13. The non-transitory processor-readable medium of claim 8, wherein the promotion includes a redemption limit such that the promotion expires after a predetermined number of users redeem the promotion.

14. The non-transitory processor-readable medium of claim 8, wherein the promotion is a recurring promotion associated with an event.

15. The non-transitory processor-readable medium of claim 8, wherein the first set of parameters includes at least one of an identifier of a user of the second communication device and an identifier of the loyalty program of the vendor.

16. The non-transitory processor-readable medium of claim 8, wherein the first set of parameters includes at least one of an identifier of the user, an expiration date of the promotion, an identifier of a location at which the promotion is valid, and a parameter of the promotion.

17. A system, comprising:
a search module to retrieve, from a vendor database, an indicator of each vendor from a plurality of vendors within a geographic area having registered loyalty programs such that a communication device can display a representation of a geographic location of each vendor from the plurality of vendors on a map of the geographic area based on the indicator of each vendor from the plurality of vendors;
an initiation module to receive an indication from the communication device that a user has selected to subscribe to a loyalty program of a vendor from the plurality of vendors, the initiation module to send an indicator associated with the loyalty program to the communication device; and
a redemption module to increment a use counter associated with the user and the loyalty program in response to receiving an indication from the vendor that the user has presented the indicator to the vendor in association with the loyalty program, the redemption module to provide feedback to the vendor in response to the user presenting the indicator to the vendor, the feedback including demographic information of the user.

18. The system of claim 17, further comprising:
a promotion module to send a promotion to the communication device in response to the vendor initiating the promotion, the promotion being associated with at least one of a geographic area of the communication device, a demographic category of the user, a place of work of the user or the user's association with the loyalty program of the vendor.

19. The system of claim 15, wherein the redemption module is to provide an indication of a reward to the communication device when the use counter is greater than a predetermined threshold.

20. The system of claim 17, wherein the geographic area is selected based on a Global Positioning System signal associated with the communication device.

21. The system of claim 15, wherein the geographic area is selected based on a location indicator entered by the user of the communication device.

22. The system of claim 17, wherein the initiation module is to send a barcode to the communication device in response to receiving the indication from the communication device that the user has selected to subscribe to the loyalty program, the barcode encodes an identifier of the user and an identifier of the loyalty program of the vendor such that the vendor can track the participation of the user in the loyalty program by scanning the barcode.
